(19) United States
(12) Patent Application Publication
(10) Pub. No.: US 2014/0355094 A1
(43) Pub. Date: Dec. 4, 2014

(54) MICROMECHANICAL STRUCTURE AND CORESPONDING MANUFACTURING METHOD

(71) Applicants: Nicolas SCHORR, Bad Saeckingen (DE); Friedjof HEUCK, Stuttgart (DE); Achim TRAUTMANN, Leonberg (DE); Johannes BAADER, Wannweil (DE); Franziska ROHLFING, Leonberg (DE); Stefan PINTER, Reutlingen (DE); Rainer STRAUB, Ammerbuch (DE)

(72) Inventors: Nicolas SCHORR, Bad Saeckingen (DE); Friedjof HEUCK, Stuttgart (DE); Achim TRAUTMANN, Leonberg (DE); Johannes BAADER, Wannweil (DE); Franziska ROHLFING, Leonberg (DE); Stefan PINTER, Reutlingen (DE); Rainer STRAUB, Ammerbuch (DE)

(73) Assignee: ROBERT BOSCH GMBH, Stuttgart (DE)

(21) Appl. No.: 14/247,083

(22) Filed: Apr. 7, 2014

(30) Foreign Application Priority Data
Apr. 11, 2013 (DE) 10 2013 206 377.6

(51) Int. Cl. G02B 26/08

(52) U.S. Cl. CPC G02B 26/0833
USPC 359/223.1; 216/24

(57) ABSTRACT

A micromechanical structure includes a substrate having an upper side and a lower side, the substrate having a first region and a second region adjacent thereto, the upper side being fashioned in the first region as a mirror region that reflects light. In the second region on the upper side of the substrate, a network-type structure and/or a web-type structure is fashioned, such that the second region is essentially non-light-reflective.

### BACKGROUND OF THE INVENTION

1. Field of the Invention

The present invention relates to a micromechanical structure and to a corresponding production method.

2. Description of the Related Art

Although it is applicable to arbitrary optical materials, the present invention and the problem on which it is based are explained on the basis of silicon.

Given the use of silicon as a base material for micromechanical components in optical applications, e.g. for micromirrors for projection applications, as known from published international patent application document WO 2009/019086 A1, the reflectance and absorbance of the surface play a large role.

A high reflectance is required on the actual mirror surface of a micromirror. For visible light, given perpendicular incidence, silicon has a degree of reflection of only about 35%. In order to increase the degree of reflection on such mirror surfaces to a higher level, thin metallic layers can be applied, e.g. of silver or aluminum. With the use of silver, for visible light a degree of reflection of approximately 95% is reached. In other areas of the component, i.e. on all silicon surfaces with the exception of the actual mirror surface, e.g. at the anchor points of a rotating mirror, the surface should absorb the light as effectively as possible. This is because light that is reflected by these surfaces commonly produces undesired blooms that in the case of the micromirror can have a disturbing appearance as artifacts in the produced image, and can greatly reduce the contrast that can be achieved.

Typically, in order to increase the degree of absorption of a substrate material in the relevant regions an anti-reflective layer is applied to the surface thereof. This is made up of a thin layer of a transparent material whose index of refraction is between that of air and that of the substrate material.

A problem with this type of surface treatment is that its quality is a function both of the wavelength and of the angle of incidence of the light. A simple anti-reflection layer works optimally only for one wavelength and one angle of incidence. An improvement can be achieved by using a system of layers of different materials. However, even in this way it is not possible to achieve an optimal treatment for a large wavelength range and for arbitrary angles of incidence.

For the use of the micromirror in a projection module, standardly three different wavelengths are used (red, green, and blue light). In particular, the light can impinge on the surfaces from a large angular spectrum. An absorbing layer as anti-reflection layer, independent of wavelength and angle, is provided by black silicon. This black silicon is a surface modification of silicon that results from reactive ion etching of silicon with particular process parameters, as described for example in J. Micromech. Microeng. 5 (1995), pp. 115-120.

Through the etching method described there, there arise long thin tips of silicon that can be several 10 μm and can have a diameter less than 1 μm. These cover the overall silicon surface like grass, and cause it to appear black, because they drastically reduce the reflectance for visible light. The fine, exposed silicon tips can however easily be destroyed in subsequent process steps.

### BRIEF SUMMARY OF THE INVENTION

The present invention creates a mechanically and thermally stable closed and chemically inert surface that has a substrate region in the manner of webs or a network, alongside an unstructured substrate region.

The optical properties of this web-type or network-type substrate region are such that it strongly absorbs visible light. The absorption is independent both of the angle of incidence of the light and of its wavelength. The surface therefore appears black. In these properties, the structure according to the present invention deviates from previously known structures, and as it were combines the stable properties of a known anti-reflection layer, e.g. made of silicon nitride, with the particular optical properties of black silicon.

Production takes place using standard microstructuring methods, and can for example be integrated into the standard process sequence for the production of micromirrors, inter alia, without additional process outlay. Because in a first step the structuring is carried into the silicon using photolithography and reactive ion etching, in this step it is already possible to define all regions that are to be absorbent, and those that are to retain the reflectance of the substrate material, e.g. of the silicon, or of one or more thin metallic layers applied thereon. In particular, the possibility of structuring these light-absorbing regions in the initial process step, and subsequently being able to further process them with only minimal limitation, is extremely advantageous.

According to a preferred specific embodiment, the network-type structure has holes that are separated by connected webs. Such a network structure is can be produced in particularly stable fashion.

According to a further preferred specific embodiment, the web-type structure has trenches separated by webs. This structure has particularly good absorption characteristics.

According to a further preferred specific embodiment, the network-type structure and/or the web-type structure is filled with a first material transparent to light that extends over the entire surface in the first region and extends at least up to the upper side in the second region.

According to a further preferred specific embodiment, the substrate is a silicon substrate and the first material transparent to light is silicon oxide. In micromechanical structures, this combination of materials has been extremely well tested and proven.

According to a further preferred specific embodiment, the network-type structure and/or the web-type structure is covered with a light-reflecting layer on the upper side and on the floor, and optionally is also covered with a light-reflecting layer with a reduced layer thickness on the side walls and in the first region over the entire surface. In this way, the reflectance in the mirror region can be increased without having an influence on the absorbing region.

According to a further preferred specific embodiment, the light-reflecting layer is a metallic layer. In this case, a very thin layer is sufficient, e.g. in the case of silver or aluminum.

According to a further preferred specific embodiment, the network-type structure and/or the web-type structure has a structural depth in the range of from 30 to 300 micrometers.

According to a further preferred specific embodiment, the network-type structure and/or the web-type structure has a structural width in the range of from 0.5 to 5 micrometers.

### BRIEF DESCRIPTION OF THE DRAWINGS

FIGS. 1a), 1b) and FIGS. 2a), 2b) show schematic representations of a micromechanical structure according to a first specific embodiment of the present invention, FIGS. 1a) and 2a) in a top view and FIGS. 1b) and 2b) in vertical cross-section along line A-A′ in FIG. 1a) or, respectively, 2a).

FIGS. 3a), 3b) and FIGS. 4a), 4b) show schematic representations of a micromechanical structure according to a second specific embodiment of the present invention, FIGS. 3a) and 4a) in a top view and FIGS. 3b) and 4b) in vertical cross-section along line A-A′ in FIG. 3a) or, respectively, 2a).

FIGS. 5a), 5b) show schematic representations of a micromechanical structure according to a third specific embodiment of the present invention, FIG. 5a) in a top view and FIG. 5b) in vertical cross-section along line A-A′ in FIG. 5a).

FIGS. 6a), 6b) show schematic representations of a micromechanical structure according to a fourth specific embodiment of the present invention, FIG. 6a) in a top view and FIG. 6b) in vertical cross-section along line A-A′ in FIG. 6a).

### DETAILED DESCRIPTION OF THE INVENTION

In the Figures, identical reference characters designate identical or functionally identical elements.

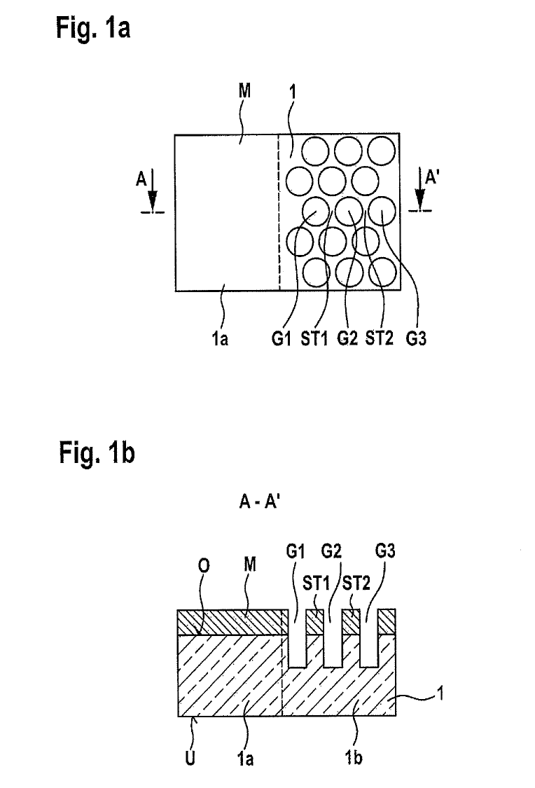

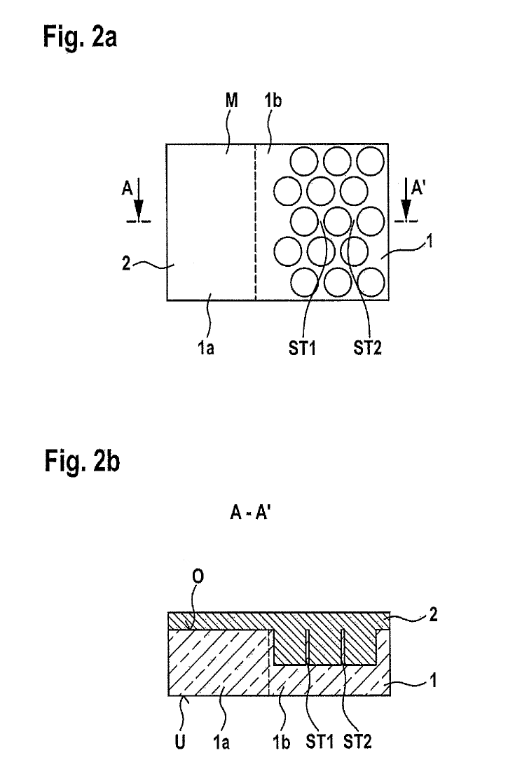

FIGS. 1a), b) and FIGS. 2a), b) are schematic representations of a micromechanical structure according to a first specific embodiment of the present invention, FIGS. 1a) and 2a) in a top view and FIGS. 1b) and 2b) in vertical cross-section along line A-A′ in FIG. 1a) or, respectively, 2a).

In FIGS. 1a), b), reference character 1 designates a silicon substrate having an upper side O and a lower side U on which there is deposited an etching mask M, e.g. of silicon nitride, as trench etching mask. Using a known trench etching process, through the presence of corresponding holes in etching mask M holes G1, G2, G3, etc., with web regions ST1, ST2, etc. positioned between them, are etched in a region 1b of the silicon substrate, the holes structuring region 1b to form a network-type substrate region made of silicon. Etching mask M is sealed in region 1a of the silicon substrate, and for this reason no etching attack takes place there and the substrate material remains unstructured.

In a following process step, illustrated in FIGS. 2a), b), after removal of etching mask M there then takes place a thermal oxidation of upper side O of silicon substrate 1 to form a silicon oxide layer 2, holes G1, G2, G3 being closed, and the oxidation continuing laterally in region 1b into the silicon, causing web regions ST1, ST2 to become narrower.

During the thermal oxidation the silicon is converted into silicon dioxide, the resulting silicon oxide layer 2 growing 45% into the silicon and growing 55% out of the silicon. Regions that are intended to be reflective later, or that are not to be given a network-type structure due to other functions, are oxidized on the surface. However, a structuring of the surface, or e.g. roughening, does not take place. Only web regions ST1, ST2 in region 1b become narrower, and the trenches are filled with silicon dioxide.

The resulting network-type silicon structure in region 1b is determined in the present case by the large number of holes G1, G2, G3, etc., resulting from the etching step, these holes being configured for example in a tight, or tightest, sphere packing. Here, the size and spacing of the holes G1, G2, G3, etc., which in the present case are circular, after the etching step is preferably selected such that after the thermal oxidation the silicon webs ST1, ST2 embedded in silicon oxide layer 2 are less than 1 μm wide.

After the oxidation, the network-type silicon structure in region 1b appears deep black, because here the light is captured by multiple reflection at web regions ST1, ST2 and is finally absorbed. Unstructured region 1a of the substrate has a bright appearance, because here the light continues to be reflected well at upper side O of substrate 1, the silicon oxide at upper side O′ having a reflectivity of only 4%, and otherwise being transparent to light. Optionally, a metallic layer, for example of aluminum or silver, can also be provided in region 1a on upper side O, but not in region 1b, which is to remain absorbent, or to have low reflectivity.

Optionally, silicon oxide layer 2 can also be removed up to upper side O, e.g. in a CMP step. If the natural degree of reflection of silicon is too low for the desired application, it is then optionally possible also to provide a metallic layer, for example of aluminum or silver, in region 1a on upper side O, but not in region 1b, which is to remain absorbent, or to have low reflectivity.

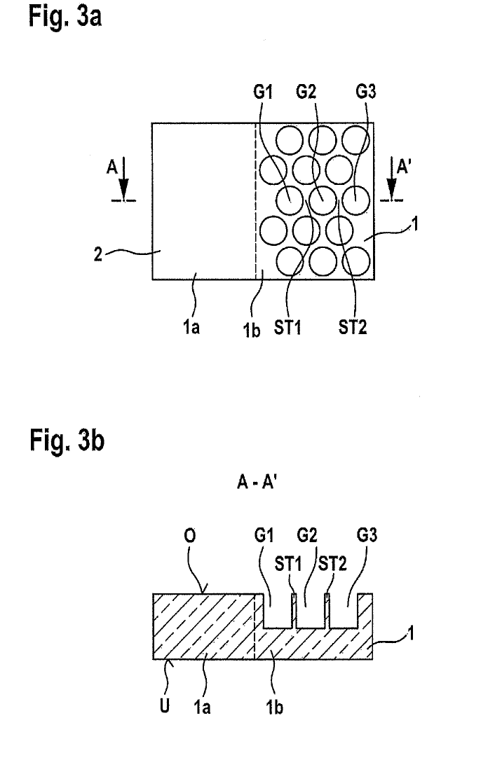

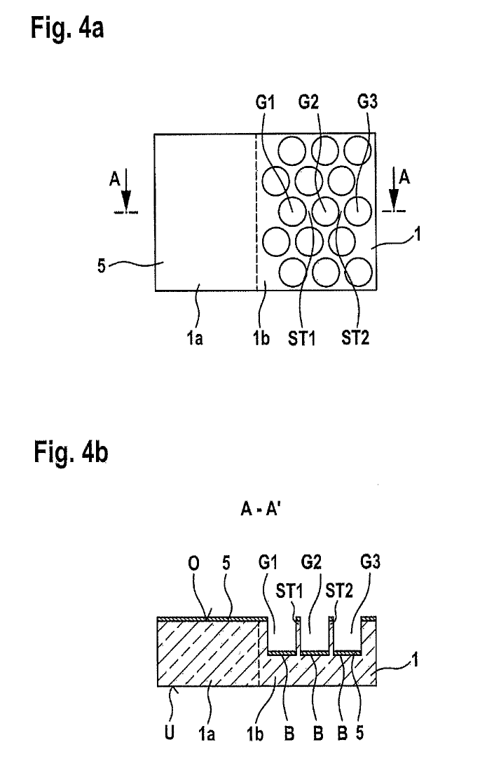

FIGS. 3a), b) and FIGS. 4a), b) are schematic representations of a micromechanical structure according to a second specific embodiment of the present invention, FIGS. 3a) and 4a) in a top view and FIGS. 3b) and 4b) in vertical cross-section along line A-A′ in FIG. 3a) or, respectively, 4a).

The initial state of the second specific embodiment according to FIGS. 3a), b) is the state shown in FIGS. 2a), b). According to this, as is shown in FIGS. 3a), b), silicon oxide layer 2 is removed by an etching step, for example in hydrofluoric acid. Thus, there remains only the network-type silicon structure in region 1b, or planar upper side O of the substrate in region 1a. Because the network-type silicon structure in region 1b is thoroughly interconnected in honeycomb fashion, it is mechanically very stable.

If the natural degree of reflection of silicon is too low for the desired application, it is also optionally possible here, as illustrated in FIGS. 4a), b), to deposit a metallic layer 5, for example of aluminum or silver, over the whole surface over the structure according to FIGS. 3a), b); here the thickness of metallic layer 5 need be only a few 10 nm.

Metallic layer 5 covers the whole surface of the horizontal regions of substrate 1, i.e., in addition to upper side O of region 1a, also floor B of widened trenches G1, G2, G3. Although floor B is covered by metallic layer 5, in this specific embodiment as well region 1b also absorbs the light very well, because, as described above, a multiple reflection occurs at web regions ST1, ST2, etc.

Thus, in this specific embodiment it is possible to achieve an increase in the reflectance in region 1a through the deposition of metallic layer 5, and at the same time to obtain region 1b having a low degree of reflection, without requiring an additional structuring of metallic layer 5, e.g. through lift-off or through a later etching step.

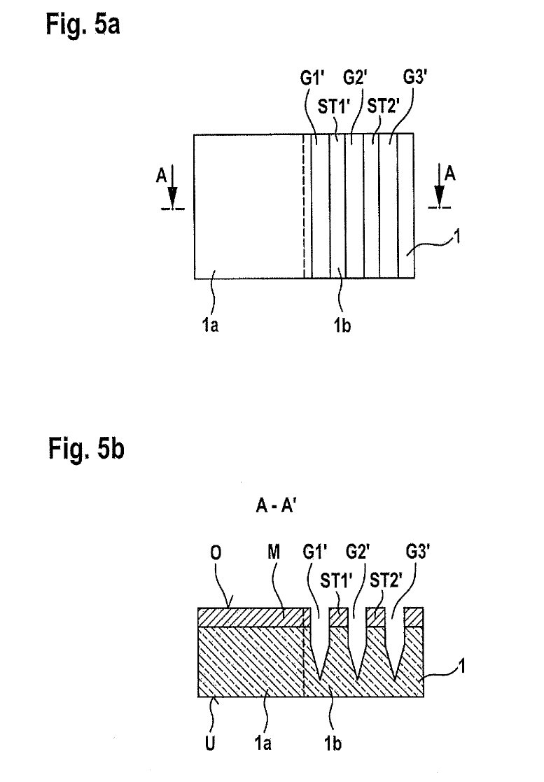

FIGS. 5a), b) are schematic representations of a micromechanical structure according to a third specific embodiment of the present invention, FIG. 5a) in a top view and FIG. 5b) in vertical cross-section along line A-A′ in FIG. 5a).

In the specific embodiment according to FIGS. 5a), b), a network-type silicon structure having holes is not provided; rather, a web-type structure is provided having webs St1′, St2′, and trenches G1′, G2′, G3′, etc., situated between them, in absorbent or non-reflecting region 1b of silicon substrate 1; for this purpose, analogous to the first and second specific embodiment an etching mask M is used in connection with a known trench etching process. The process state according to FIG. 5a), b) corresponds to the state immediately after the trench etching process.

In this third specific embodiment, the trench etching process of region 1b takes place simultaneously, in the process flow, with the exposure of large structures (not shown) such as e.g. a trench that surrounds a mirror element. Here, usefully in the trench etching method, a reactive ion etching method, the ARDE effect is exploited, in which the etching depth is a function of the size of the structure that is to be opened. In the ARDE effect, structures having a smaller opening surface are etched less deeply than structures having a larger opening surface. For example, at the same time at a different location large structures having 250 μm etching depth, and region 1b having 150 μm etching depth, can be etched. As can be seen in FIG. 1b), trenches G1′, G2′, G3′ become narrower as the etching depth increases.

In this third specific embodiment, in contrast to the specific embodiments described above, no oxidation takes place after the trench etching method. Rather, region 1b having the web structure is defined only by the trench etching process.

Optionally, in this third specific embodiment mask M can be removed. In addition, in the third specific embodiment, analogous to the second specific embodiment, a metallic layer can optionally be deposited in order to increase the reflectance in restructured region 1a of silicon substrate 1; here as well, the deposition of such a metallic layer has no influence on the absorbance of region 1b.

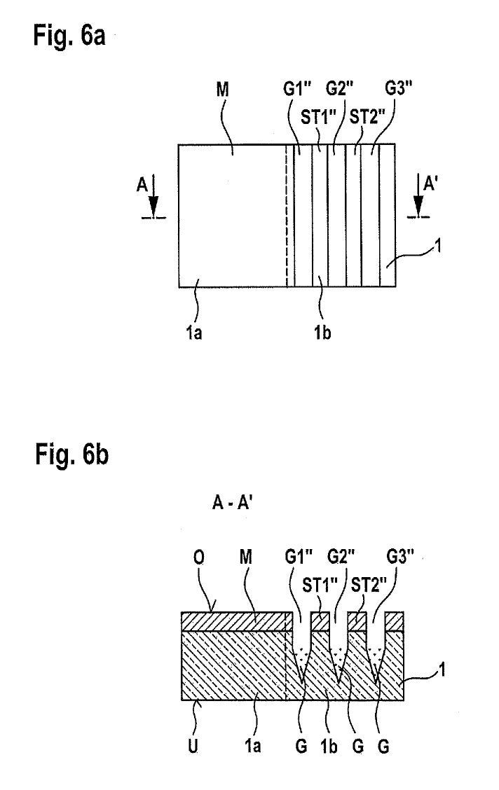

FIGS. 6a), b) are schematic representations of a micromechanical structure according to a fourth specific embodiment of the present invention, FIG. 6a) in a top view and FIG. 6b) in vertical cross-section along line A-A′ in FIG. 6a).

In the fourth specific embodiment according to FIG. 6a), b), a web-type structure is provided as in the third specific embodiment, the webs being designated with reference characters St1″ and St2″, and the trenches between them being designated with reference characters G1″, G2″, G3″, etc.

Differing from the third specific embodiment, in the fourth specific embodiment the trench etching process is set such that in the lower regions of trenches G1′, G2″, G3″ so-called silicon grass (black silicon) arises, which further reinforces the effect of light absorption in region 1b.

Measurements have been carried out on test structures that show that, given suitable selection of the web-type structure and of the network-type structure, a low reflectance can be achieved over a large wavelength range.

Although the present invention has been completely described above on the basis of preferred exemplary embodiments, it is not limited thereto, but can be modified in many ways.

Although in the above specific embodiments silicon has been used as substrate material, other substrate materials may also be used, such as germanium or other materials that are reflective or that can be coated with a reflecting layer.

The depicted web-type or network-type structures have also been selected only as examples, and arbitrary other structures having trenches, or holes, can be used to bring about the same absorption effect alongside a reflecting surface.

1-14. (canceled)

15. A micromechanical structure, comprising:
a substrate having an upper side, a lower side, a first lateral region, and a second lateral region adjacent to the first lateral region;
wherein the upper side in the first lateral region is configured as a mirror region which reflects light, and wherein at least one of a network-type structure and a web-type structure is configured in the second lateral region on the upper side such that the upper side of the second lateral region is essentially non-light-reflective.

16. The micromechanical structure as recited in claim 15, wherein the network-type structure has holes which are separated by connected webs.

17. The micromechanical structure as recited in claim 16, wherein the web-type structure has trenches which are separated by webs.

18. The micromechanical structure as recited in claim 17, wherein a first material transparent to light is provided in the upper side of the first and second lateral regions, and wherein the at least one of the network-type structure and the web-type structure is filled with the first material transparent to light.

19. The micromechanical structure as recited in claim 18, wherein the substrate is a silicon substrate, and the first material transparent to light is a silicon oxide layer.

20. The micromechanical structure as recited in claim 18, wherein the upper side of the first lateral region is covered with a light-reflecting layer, and wherein a floor and the upper side the at least one of the network-type structure and the web-type structure are covered with the light-reflecting layer.

21. The micromechanical structure as recited in claim 20, wherein the light-reflecting layer is a metallic layer.

22. The micromechanical structure as recited in claim 20, wherein the at least one of the network-type structure and the web-type structure has a structural depth in the range of 30 to 300 micrometers.

23. The micromechanical structure as recited in claim 20, wherein the at least one of the network-type structure and the web-type structure has a structural width in the range of 0.5 to 5 micrometers.

24. A method for producing a micromechanical structure having a substrate with an upper side, a lower side, a first lateral region, and a second lateral region adjacent to the first lateral region, wherein the upper side in the first lateral region is configured as a mirror region which reflects light, and wherein at least one of a network-type structure and a web-type structure is configured in the second lateral region on the upper side such that the upper side of the second lateral region is essentially non-light-reflective, the method comprising:
forming an etching mask on the upper side of the substrate;
structuring, using the etching mask, the second lateral region in an etching step to form the at least one of the network-type structure and the web-type structure; and
removing the etching mask.

25. The method as recited in claim 24, further comprising:
after the removal of the etching mask, (i) filling the at least one of the network-type structure and the web-type structure in the second lateral region with a first material which is transparent to light, and (ii) providing the first material transparent to light in the upper side of the first and second lateral regions.

26. The method as recited in claim 25, wherein the substrate is a silicon substrate, the first material transparent to light is silicon oxide, and the filling takes place through a thermal oxidation step.

27. The method as recited in claim 26, further comprising:
removing the first material transparent to light.

28. The method as recited in claim 25, further comprising:
in a vapor deposition step, (i) covering the upper side of the first lateral region with a light-reflecting layer, and (ii) covering a floor and the upper side of the at least one of the network-type structure and the web-type structure with the light-reflecting layer.
